(19) United States
(12) Patent Application Publication
(10) Pub. No.: US 2026/0277287 A1
(43) Pub. Date: Sep. 17, 2026

(54) ENERGY-SAVING APPARATUS, AND COMMUNICATION DEVICE AND OPERATION METHOD THEREFOR

(71) Applicant: ZTE CORPORATION, Shenzhen, Guangdong (CN)

(72) Inventors: Xueyin GOU, Shenzhen, Guangdong (CN); Guangde WU, Shenzhen, Guangdong (CN); Jun MA, Shenzhen, Guangdong (CN); Hongtao GUO, Shenzhen, Guangdong (CN); Haibo CHEN, Shenzhen, Guangdong (CN)

(21) Appl. No.: 18/871,531

(22) PCT Filed: Jun. 25, 2023
(86) PCT No.: PCT/CN2023/102021

§ 371 Date: Dec. 4, 2024

(30) Foreign Application Priority Data
Jun. 27, 2022 (CN) 202210736900.7

(51) Int. Cl. G06F 1/26; G06F 1/3287

(52) U.S. Cl. CPC G06F 1/263; G06F 1/3287

(57) ABSTRACT

The present disclosure provides an energy-saving apparatus used in a communication device including an optical module and an operating module. The energy-saving apparatus includes a power control unit, a first power supply unit configured to supply power to the power control unit and the optical module, and a second power supply unit configured to supply power to the operating module. The power control unit is configured to control, when the second power supply unit supplies power, the second power supply unit to stop supplying power in response to the optical module not receiving an optical signal within a preset period of time, and control, when the second power supply unit stops supplying power, the second power supply unit to supply power in response to the optical module receiving the optical signal. The present disclosure further provides a communication device and an operation method therefor.

### CROSS-REFERENCE TO RELATED APPLICATIONS

The present disclosure claims the priority to Chinese Patent Application No. CN202210736900.7 entitled “ENERGY-SAVING APPARATUS, AND COMMUNICATION DEVICE AND OPERATION METHOD THEREFOR” and filed on Jun. 27, 2022, the contents of which are incorporated herein by reference in their entirety.

### TECHNICAL FIELD

The present disclosure relates to the technical field of power management, and in particular, to an energy-saving apparatus, and a communication device and an operation method therefor.

### BACKGROUND

In a mobile communication network, the electricity consumption of a base station is very high, especially the electricity consumption of a remote radio unit (RRU) or an active antenna unit (AAU).

In order to reduce the power of the RRU/AAU to save energy, part of modules in the RRU/AAU, such as a radio frequency module, may be turned off when no service needs to be processed in the base station, but such energy-saving method cannot produce an ideal energy saving effect.

### SUMMARY

An embodiment of the present disclosure provides an energy-saving apparatus used in a communication device, the communication device including an optical module and an operating module, and the operating module being configured to operate according to an optical signal received by the optical module, wherein the energy-saving apparatus includes a power control unit, a first power supply unit, and a second power supply unit; the first power supply unit is configured to supply power to the power control unit and the optical module; the second power supply unit is configured to supply power to the operating module; and the power control unit is configured to control, when the second power supply unit supplies power to the operating module, the second power supply unit to stop supplying power to the operating module in response to the optical module not receiving the optical signal within a preset period of time, and control, when the second power supply unit stops supplying power to the operating module, the second power supply unit to supply power to the operating module in response to the optical module receiving the optical signal.

An embodiment of the present disclosure further provides a communication device, including an optical module, an operating module, and the energy-saving apparatus according to the embodiment of the present disclosure, wherein the operating module is configured to operate according to an optical signal received by the optical module; the power control unit of the energy-saving apparatus is connected to the optical module; the first power supply unit of the energy-saving apparatus is connected to the optical module; and the second power supply unit of the energy-saving apparatus is connected to the operating module.

An embodiment of the present disclosure further provides an operation method for the communication device according to the embodiment of the present disclosure, and the method including: when the second power supply unit supplies power to the operating module, in response to the optical module not receiving the optical signal within the preset period of time, controlling, by the power control unit, the second power supply unit to stop supplying power to the operating module; and when the second power supply unit stops supplying power to the operating module, in response to the optical module receiving the optical signal, controlling, by the power control unit, the second power supply unit to supply power to the operating module.

### BRIEF DESCRIPTION OF DRAWINGS

In the drawings for the embodiments of the present disclosure:

FIG. 1 is a block diagram of an energy-saving apparatus according to an embodiment of the present disclosure;

FIG. 2 is a block diagram of a communication device according to an embodiment of the present disclosure;

FIG. 3 is another block diagram of a communication device according to an embodiment of the present disclosure; and

FIG. 4 is a flowchart illustrating an operation method for a communication device according to an embodiment of the present disclosure.

### DETAIL DESCRIPTION OF EMBODIMENTS

In order to enable those of ordinary skill in the art to better understand the technical solutions of the present disclosure, an energy-saving apparatus, and a communication device and an operation method therefor provided in the embodiments of the present disclosure are described in detail below with reference to the drawings.

The present disclosure will be described more fully below with reference to the drawings, but the embodiments illustrated may be embodied in different forms, and the present disclosure should not be interpreted as being limited to the embodiments described below. Rather, the embodiments are provided to make the present disclosure thorough and complete, and are intended to enable those of ordinary skill in the art to fully understand the scope of the present disclosure.

The drawings for the embodiments of the present disclosure are intended to provide a further understanding of the embodiments of the present disclosure and constitute a part of the specification. Together with the specific embodiments of the present disclosure, the drawings are used to explain the present disclosure, but do not constitute any limitation to the present disclosure. The above and other features and advantages will become more apparent to those of ordinary skill in the art from the description of the specific embodiments with reference to the drawings.

The present disclosure can be described with reference to plans and/or cross-sectional views with the aid of idealized schematic diagrams of the present disclosure. Accordingly, the exemplary drawings may be modified according to manufacturing techniques and/or tolerances.

All the embodiments of the present disclosure and the features therein may be combined with each other if no conflict is incurred.

The terms used herein are merely used to describe the specific embodiments, and are not intended to limit the present disclosure. The term “and/or” used herein includes any and all combinations of one or more associated listed items. The terms “one” and “the” used herein which indicate a singular form are intended to include a plural form, unless expressly stated in the context. The terms “include” and “be made of” used herein indicate the presence of the described features, integers, operations, elements and/or components, but do not exclude the presence or addition of one or more other features, integers, operations, elements, components and/or combinations thereof.

Unless otherwise defined, all terms (including technical and scientific terms) used herein have the same meaning as commonly understood by those of ordinary skill in the art. It should be further understood that terms, such as those defined in commonly used dictionaries, should be interpreted as having a meaning that is consistent with a meaning in the context of the related technology and the background of the present disclosure, and should not be interpreted in an idealized or overly formal sense unless expressly so defined herein

The present disclosure is not limited to the embodiments illustrated by the drawings, but includes modifications to configuration formed based on a manufacturing process. Thus, regions shown in the drawings are illustrative, and shapes of the regions shown in the drawings illustrate specific shapes of regions of elements, but are not intended to make limitations.

In the mobile communication network, the electricity consumption of the base station is very high, especially the electricity consumption of the RRU or the AAU, and the power of the RRU or the AAU can reach several hundreds of watts.

In some related technologies, in order to reduce the power of the RRU/AAU to save energy, when no service needs to be processed in the base station, an energy-saving control signal may be sent by a building baseband unit (BBU) to a main control processor (i.e., a main central processing unit (CPU)) of the RRU/AAU, so as to enable the main control processor to turn off part of the modules in the RRU/AAU, such as turning off the radio frequency module; and when a service needs to be processed in the base station, the BBU sends a restoring signal to the main control processor, so as to enable the main CPU to re-start the closed module.

As can be seen, since the main control processor (the main CPU) is desired to analyze the signals and control the other modules in the above method, the main control processor and a digital processing unit cannot be turned off and are desired to be on at any time when no service needs to be processed in the base station. Due to the high power consumption of the main control processor and the digital processing unit, the above method cannot produce an ideal energy-saving effect, and can save energy by about 90% at most.

An embodiment of the present disclosure provides an energy-saving apparatus used in a communication device, and the communication device includes an optical module (OM) and an operating module configured to operate according to an optical signal received by the optical module.

Referring to FIG. 2, an embodiment of the present disclosure provides an energy-saving apparatus used in the communication device, that is, the communication device uses the energy-saving apparatus as a power supply for supplying power (so the energy-saving apparatus may be regarded as a power supply capable of saving energy), and the communication device further includes the optical module and the operating module, so the optical module and the operating module are also powered by the energy-saving apparatus to operate.

The optical module is a module which may be connected to an optical fiber and transmit and receive optical signals through the optical fiber to achieve communication. The operating module may operate according to an optical signal received by the optical module, that is, when the optical module receives an optical signal, the operating module may analyze and process the optical signal and operate accordingly; and when the optical module does not receive the optical signal, the operating module does not operate “actively” according to other signals.

In some embodiments, the communication device includes at least one of an AAU or an RRU.

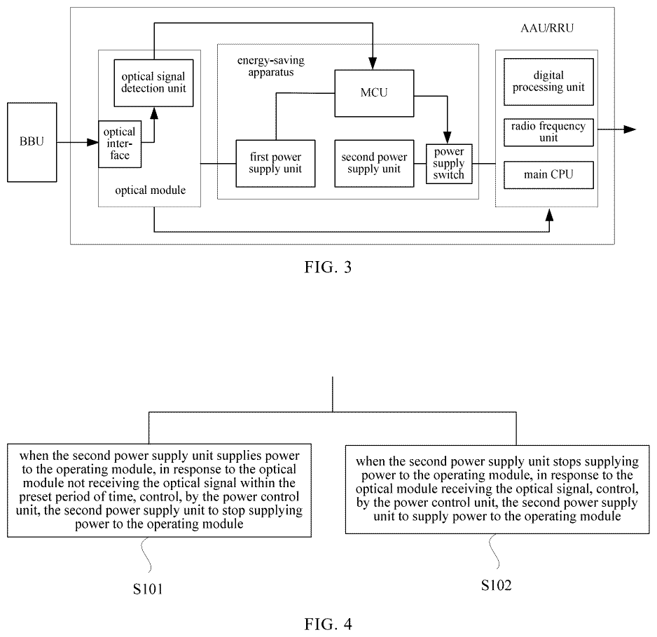

Referring to FIG. 3, in an implementation of the embodiments of the present disclosure, the communication device may be in a form of an AAU or an RRU.

The optical module of the AAU/RRU may be connected to an optical module of a BBU through an optical fiber. After the optical module of the BBU sends an optical signal to the optical module of the AAU/RRU, the AAU/RRU may convert the optical signal into a radio frequency signal and send the radio frequency signal via an air interface (antenna port), and may further receive a signal sent by user equipment via the air interface to process.

In some embodiments, the operating module includes at least one of a digital processing unit or a radio frequency unit.

Referring to FIG. 3, the operating module of the AAU/RRU may include the digital processing unit for processing data, and the radio frequency unit for achieving reception and transmission of radio frequency signals.

In some embodiments, the operating module includes a main control processor for controlling operation of the communication device.

Referring to FIG. 3, in an implementation of the embodiments of the present disclosure, the operating module may include the main control processor, i.e., a main CPU which controls the operation of the communication device.

As stated above, in the related technologies, since the main control processor is desired to process the restoring signal to control the other modules to resume operation, the main control processor itself cannot be turned off when no service needs to be processed, such that the main control processor still consumes a large amount of energy.

In the embodiments of the present disclosure, the main control processor is also a part of the operating module, so that the main control processor can be turned off, which improves the energy saving effect.

It should be understood that the communication device and the operating module according to the embodiments of the present disclosure are not limited to the above specific examples, and in a case where the communication device is a communication device of another type, the operating module may include other units.

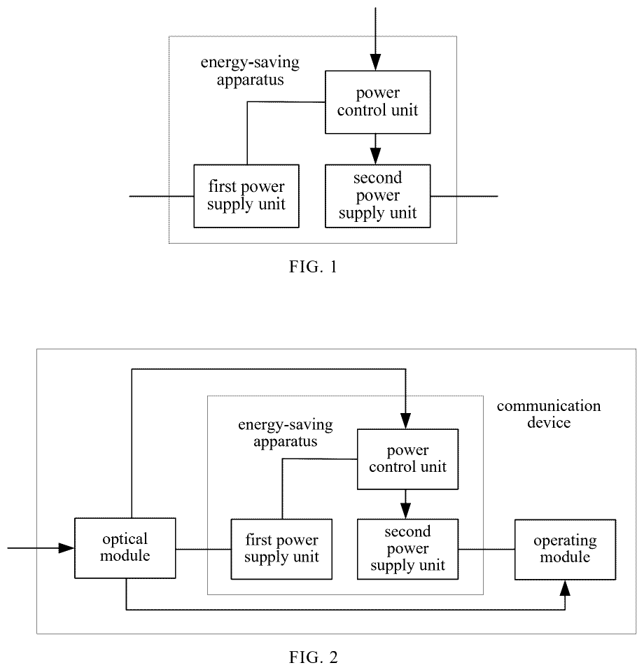

Referring to FIG. 1, an energy-saving apparatus according to an embodiment of the present disclosure includes a power control unit, a first power supply unit, and a second power supply unit.

The first power supply unit is configured to supply power to the power control unit and the optical module.

The second power supply unit is configured to supply power to the operating module.

The power control unit is configured to control, when the second power supply unit supplies power to the operating module, the second power supply unit to stop supplying power to the operating module in response to the optical module not receiving an optical signal within a preset period of time, and control, when the second power supply unit stops supplying power to the operating module, the second power supply unit to supply power to the operating module in response to the optical module receiving the optical signal.

Referring to FIG. 1, the energy-saving apparatus according to the embodiment of the present disclosure includes two power supply units, with the first power supply unit configured to supply power to the power control unit and the optical module in the communication device, and the second power supply unit configured to supply power to the operating module in the communication device.

The energy-saving apparatus according to the embodiment of the present disclosure further includes the power control unit, which is connected to the optical module in the communication device and is capable of controlling the second power supply unit according to whether the optical module receives an optical signal.

When the second power supply unit supplies power to the operating module, if the optical module does not receive the optical signal for the preset period of time, which indicates that no service needs to be processed, the power control unit controls the second power supply unit to stop supplying power to the operating module, so as to enable the operating module to stop operating and enter an energy-saving mode, thereby achieving the energy-saving effect.

After the second power supply unit stops supplying power to the operating module (that is, in the energy-saving mode), if the optical module suddenly receives the optical signal, which indicates that a service needs to be operated, the power control unit controls the second power supply unit to supply power to the operating module, so as to enable the operating module to start to operate and process a communication service.

Since the power control unit and the optical module are powered by the first power supply unit, the power control unit and the optical module can keep operating when the operating module is turned off (that is, the second power supply unit stops supplying power), so as to monitor whether the optical signal arrives.

In the embodiments of the present disclosure, the power control unit can monitor whether the optical signal arrives at the optical module, and can perform control to stop the power supply to the operating module in response to a long period of time of no optical signal, so that the operating module can be turned off and enter the energy-saving mode; and the power control unit can further perform control to restore the power supply to the operating module in response to the arrival of the optical signal, so that the operating module can normally process the optical signal.

According to the embodiments of the present disclosure, whether the communication device operates can be controlled with the power control unit in the energy-saving apparatus; and in the energy-saving mode, merely the optical module and the power control unit need to be turned on and the operating module (which may include the main control processor) can be completely turned off. Thus, energy consumption (merely a few watts) in the energy-saving mode can be further reduced, and the energy saving effect can be improved (saving energy by 99%).

In some embodiments, the preset period of time is in a range between 15 minutes and 30 minutes.

Specifically, a time threshold (the preset period of time) used for stopping the operation of the operating module may be set to be from 15 minutes to 30 minutes, for example, the time threshold is 20 minutes or 25 minutes.

It should be understood that the specific value of the time threshold may be set according to a practical situation, and the value may be within the above range, or the time threshold may be set to other time values.

In some embodiments, the power control unit includes a micro controller unit (MCU).

In an implementation of the embodiments of the present disclosure, the power control unit may be in a form of an MCU. Compared with a processor (e.g., a CPU), the MCU can perform simple control according to relatively simple rules, meet requirements of the embodiments of the present disclosure, and has much lower energy consumption.

In some embodiments, an output terminal of the second power supply unit is connected to a power supply switch, and the power control unit controls the second power supply unit to supply power to the operating module or stop supplying power to the operating module by turning on or turning off the power supply switch.

Referring to FIG. 3, in an implementation of the embodiments of the present disclosure, the power supply switch may be connected to the output terminal of the second power supply unit, so that whether the second power supply unit supplies power to the operating module may be controlled by controlling on or off of the power supply switch.

It should be understood that a specific method of the power control unit for controlling the second power supply unit is not limited to the above. For example, the power control unit may directly control on or off of the second power supply unit.

Referring to FIG. 2, an embodiment of the present disclosure provides a communication device, including an optical module, an operating module, and an energy-saving apparatus.

The operating module is configured to operate according to the optical signal received by the optical module.

The energy-saving apparatus is the energy-saving apparatus according to any one of the embodiments of the present disclosure.

The power control unit of the energy-saving apparatus is connected to the optical module; the first power supply unit of the energy-saving apparatus is connected to the optical module; and the second power supply unit of the energy-saving apparatus is connected to the operating module.

In an implementation of the embodiments of the present disclosure, the above energy-saving apparatus may be used in the communication device including the optical module and the operating module.

The operating module may operate according to the optical signal received by the optical module, that is, when the optical module receives an optical signal, the operating module may analyze and process the optical signal and operate accordingly; and when the optical module does not receive the optical signal, the operating module does not operate “actively” according to other signals.

In some embodiments, the communication device includes at least one of an AAU or an RRU.

Referring to FIG. 3, in an implementation of the embodiments of the present disclosure, the communication device may be in a form of an AAU or an RRU.

In some embodiments, the operating module includes at least one of a digital processing unit or a radio frequency unit.

Referring to FIG. 3, the operating module of the AAU/RRU may include the digital processing unit for processing data, and the radio frequency unit for achieving reception and transmission of radio frequency signals.

In some embodiments, the operating module includes a main control processor for controlling operation of the communication device.

Referring to FIG. 3, in an implementation of the embodiments of the present disclosure, the operating module may include the main control processor, that is, a main CPU which controls the operation of the communication device.

It should be understood that the communication device and the operating module according to the embodiments of the present disclosure are not limited to the above specific examples, and in a case where the communication device is a communication device of another type, the operating module may include other units.

In some embodiments, the optical module includes an optical signal detection unit connected to the power control unit.

The optical signal detection unit is configured to send, when no optical signal is received via an optical interface of the optical module, a first level to the power control unit, and send, when the optical signal is received via the optical interface of the optical module, a second level to the power control unit.

The power control unit is configured to control, when the second power supply unit supplies power to the operating module, the second power supply unit to stop supplying power to the operating module in response to reception of the first level lasting for the preset period of time, and control, when the second power supply unit stops supplying power to the operating module, the second power supply unit to supply power to the operating module in response to reception of the second level.

Referring to FIG. 3, in an implementation of the embodiments of the present disclosure, the optical module may include the optical signal detection unit, and the optical signal detection unit may monitor whether the optical signal is received via the optical interface of the optical module, and may generate the first level (e.g., a high level) and send the first level to the power control unit when no optical signal is received via the optical interface, and generate the second level (e.g., a low level) and send the second level to the power control unit when the optical signal is received via the optical interface.

Thus, the power control unit can control the second power supply unit to stop supplying power to the operating module when the reception of the first level lasts for the preset period of time, and control the second power supply unit to supply power to the operating module when the second level is received.

Referring to FIG. 4, an embodiment of the present disclosure provides an operation method for the communication device according to any one of the embodiments of the present disclosure, and the method includes the following operations S101 and S102.

At operation S101, when the second power supply unit supplies power to the operating module, in response to the optical module not receiving the optical signal within the preset period of time, the power control unit controls the second power supply unit to stop supplying power to the operating module.

At operation S102, when the second power supply unit stops supplying power to the operating module, in response to the optical module receiving the optical signal, the power control unit controls the second power supply unit to supply power to the operating module.

According to the operation method for the communication device provided in the embodiment of the present disclosure, whether the operating module operates is determined under the control of the power control unit according to the reception of the optical signal by the optical module.

It should be understood that the above operations S101 and S102 are two operations separately performed in different cases, and therefore, the orders in which the two operations are numbered and described do not represent a necessary execution order of the two operations.

In a specific example of the embodiments of the present disclosure, a process of turning off the operating module includes the following operations A1 to A5.

At operation A1, the BBU turns off a transmit (Tx) module thereof, and does not transmit an optical signal.

At operation A2, the optical signal detection unit of the AAU detects that no optical signal is received via the optical interface of the optical module of the AAU, and accordingly generates a high level by conversion and sends the high level to the MCU of the energy-saving apparatus.

At operation A3, the MCU of the energy-saving apparatus receives the high level sent from the optical signal detection unit, records duration of the high level, and determines to perform energy saving when the duration reaches the preset period of time (e.g., 20 minutes).

At operation A4, the MCU sends an energy-saving signal to the power supply switch.

At operation A5, the power supply switch is turned off after receiving the energy-saving signal, and the second power supply unit stops supplying power to the operating module (including the main CPU, etc.), thereby entering the energy-saving mode.

In a specific example of the embodiments of the present disclosure, a process of restoring the operating module includes the following operations B1 to B5.

At operation B1, the BBU turns on the transmit (Tx) module thereof, and transmits an optical signal.

At operation B2, the optical signal detection unit of the AAU detects that the optical signal is received via the optical interface of the optical module of the AAU, and accordingly generates a low level by conversion and sends the low level to the MCU of the energy-saving apparatus.

At operation B3, the MCU receives the low level sent from the optical signal detection unit, and determines to cancel the energy saving and restore normal communication.

At operation B4, the MCU sends a restoring signal to the power supply switch.

At operation B5, the power supply switch is turned on, the second power supply unit restores the power supply to the operating module, and the operating module processes the optical signal received by the AAU.

It should be understood by those of ordinary skill in the art that the functional modules/units in all or some of the operations, the systems and the devices disclosed above may be implemented as software, firmware, hardware, or suitable combinations thereof.

If implemented as hardware, the division between the functional modules/units stated above is not necessarily corresponding to the division of physical components; and for example, one physical component may have a plurality of functions, or one function or operation may be performed through cooperation of several physical components.

The present disclosure discloses the exemplary embodiments using specific terms, but the terms are merely used and should be merely interpreted as having general illustrative meanings, rather than for the purpose of limitation. Unless expressly stated, it is apparent to those of ordinary skill in the art that features, characteristics and/or elements described in connection with a particular embodiment can be used alone or in combination with features, characteristics and/or elements described in connection with other embodiments. Therefore, it should be understood by those of ordinary skill in the art that various changes in the forms and the details can be made without departing from the scope of the present disclosure of the appended claims.

1. An energy-saving apparatus used in a communication device, the communication device comprising an optical module and an operating module, and the operating module being configured to operate according to an optical signal received by the optical module, wherein the energy-saving apparatus comprises a power control unit, a first power supply unit, and a second power supply unit;
the first power supply unit is configured to supply power to the power control unit and the optical module;
the second power supply unit is configured to supply power to the operating module; and
the power control unit is configured to:
control, when the second power supply unit supplies power to the operating module, the second power supply unit to stop supplying power to the operating module in response to the optical module not receiving the optical signal within a preset period of time, and
control, when the second power supply unit stops supplying power to the operating module, the second power supply unit to supply power to the operating module in response to the optical module receiving the optical signal.

2. The energy-saving apparatus of claim 1, wherein the power control unit comprises a micro controller unit.

3. The energy-saving apparatus of claim 1, wherein
an output terminal of the second power supply unit is connected to a power supply switch, and the power control unit controls the second power supply unit to supply power to the operating module or stop supplying power to the operating module by turning on or turning off the power supply switch.

4. The energy-saving apparatus of claim 1, wherein
the preset period of time is in a range between 15 minutes and 30 minutes.

5. A communication device, comprising an optical module, an operating module, and the energy-saving apparatus of claim 1, wherein
the operating module is configured to operate according to an optical signal received by the optical module; and
the power control unit of the energy-saving apparatus is connected to the optical module; the first power supply unit of the energy-saving apparatus is connected to the optical module; and the second power supply unit of the energy-saving apparatus is connected to the operating module.

6. The communication device of claim 5, wherein the optical module comprises an optical signal detection unit connected to the power control unit;
the optical signal detection unit is configured to:
send, when no optical signal is received via an optical interface of the optical module, a first level to the power control unit, and
send, when the optical signal is received via the optical interface of the optical module, a second level to the power control unit; and
the power control unit is configured to:
control, when the second power supply unit supplies power to the operating module, the second power supply unit to stop supplying power to the operating module in response to reception of the first level lasting for the preset period of time, and
control, when the second power supply unit stops supplying power to the operating module, the second power supply unit to supply power to the operating module in response to reception of the second level.

7. The communication device of claim 5, wherein the operating module comprises a main control processor for controlling operation of the communication device.

8. The communication device of claim 5, comprising at least one of:
an active antenna unit or a remote radio unit.

9. The communication device of claim 8, wherein the operating module comprises at least one of:
a digital processing unit or a radio frequency unit.

10. An operation method for a communication device, the communication device being the communication device of claim 5, and the method comprising:
when the second power supply unit supplies power to the operating module, in response to the optical module not receiving the optical signal within the preset period of time, controlling, by the power control unit, the second power supply unit to stop supplying power to the operating module; and
when the second power supply unit stops supplying power to the operating module, in response to the optical module receiving the optical signal, controlling, by the power control unit, the second power supply unit to supply power to the operating module.

11. The operation method of claim 10, wherein the optical module comprises an optical signal detection unit connected to the power control unit, and the method further comprises:
sending, by the optical signal detection unit when no optical signal is received via an optical interface of the optical module, a first level to the power control unit, and
sending, by the optical signal detection unit when the optical signal is received via the optical interface of the optical module, a second level to the power control unit.

12. The operation method of claim 11, wherein controlling, by the power control unit, the second power supply unit to stop supplying power to the operating module comprises:
controlling, by the power control unit, the second power supply unit to stop supplying power to the operating module in response to reception of the first level lasting for the preset period of time,
controlling, by the power control unit, the second power supply unit to supply power to the operating module comprises:
controlling, by the power control unit, the second power supply unit to supply power to the operating module in response to reception of the second level.

13. The operation method of claim 10, wherein an output terminal of the second power supply unit is connected to a power supply switch, and controlling, by the power control unit, the second power supply unit to stop supplying power to the operating module comprises:
turning off, by the power control unit, the power supply switch,
controlling, by the power control unit, the second power supply unit to supply power to the operating module comprises:
turning on, by the power control unit, the power supply switch.
